(19) United States
(12) Patent Application Publication
(10) Pub. No.: US 2015/0352753 A1
(43) Pub. Date: Dec. 10, 2015

(54) METHOD FOR PRODUCING A MOTOR VEHICLE COMPONENT AND MOTOR VEHICLE COMPONENT

(71) Applicant: BENTELER AUTOMOBILTECHNIK GMBH, Paderborn (DE)

(72) Inventors: Stefan Konrad, Paderborn (DE); Hermann OPDEMOM, Paderborn (DE); Kim-Henning SAUERLAND, Bielefeld (DE); Waldemar DINIUS, Paderborn (DE)

(21) Appl. No.: 14/702,983

(22) Filed: May 4, 2015

(30) Foreign Application Priority Data
May 12, 2014 (DE) 102014106621.9

(51) Int. Cl. B29C 41/20; B32B 15/08

(52) U.S. Cl. CPC B29C 41/20; B32B 15/08; B29L 2031/3002

(57) ABSTRACT

The invention relates to a motor vehicle component and a method for producing a motor vehicle component having a metallic basic element and at least one reinforcing element made of a fiber composite material. An endless fiber strand of dry fibers is deposited here on a former, in a meandering manner around the extensions such that the two-dimensional fiber semi-finished product is formed. The fiber semi-finished product is trimmed and is brought into contact with the metallic basic element, wherein the fiber semi-finished product which is saturated with resin is cured by subjection to pressure and heat and thus the at least one reinforcing element is produced and is connected nonreleasably to the basic element.

### CROSS-REFERENCE TO RELATED APPLICATIONS

This application claims the benefit of German Patent Application No. DE 10 2014 106 621.9 filed May 12, 2014, the entire contents of which are incorporated herein by reference.

### FIELD

The invention relates to a method for producing a motor vehicle component having a metallic basic element and at least one reinforcing element made of a fiber composite material, and to a motor vehicle component produced according to this method.

### BACKGROUND

It is known from the prior art to provide motor vehicle components, for example side impact members, A pillars, B pillars or bumpers, with reinforcing elements made of fiber composite material in order to improve the crash properties thereof.

For example, DE 10 2008 039 869 A1 discloses a method for producing fiber-reinforced structural components which comprise a basic structural element to be reinforced and a reinforcing element. In this case, a stack of preimpregnated fiber mats is produced, is trimmed to size and introduced into the basic structural element. The fiber mat stacks here are connected adhesively to the basic structural element with the aid of an adhesive or else with the aid of a matrix resin. The fiber mats used are generally present in the form of woven or laid fiber fabrics, and therefore an unvarying fiber orientation is always present. However, the loading of vehicle components, for example, in the event of an impact or an accident, is not always in the form such that the load paths which occur follow the profiles of the woven or laid fiber fabrics. Ideally, however, the fiber profile is matched to the profile of the load paths. Since, in the case of conventional woven or laid fiber fabrics, the fiber strands are oriented, however, along one or a few preferred directions, a multiplicity of differently oriented fiber mats would have to be laid on one another here in order to produce an optimum fiber profile, and this either allows the mat stacks to possibly become too thick or entails a disproportionately high outlay on production of the mat stacks.

Taking this as the starting point, it is the object of the present invention to provide a method with which a motor vehicle component is provided with a reinforcing element which has an improved performance during loading or in a crash situation. In addition, it is the object of the invention to provide a corresponding motor vehicle component.

The object is achieved by a method with the features of patent claim 1 or patent claim 2. The features of dependent claims 3 to 5 constitute particular refinements of the invention.

The material part of the object is achieved by a motor vehicle component with the features of claim 6.

### SUMMARY

The invention first of all relates to a method for producing a motor vehicle component having a metallic basic element and at least one reinforcing element made of a fiber composite material, comprising the following steps:
depositing an endless fiber strand of dry fibers on a former, wherein the former has extensions, the arrangement of which on the former substantially corresponds to the final contour of a fiber semi-finished product, wherein the endless fiber strand is laid in a meandering manner around the extensions such that the two-dimensional fiber semi-finished product is formed
fixing the individual fiber strand sections extending between the extensions in the position thereof with respect to one another
trimming the fiber semi-finished product
providing the fiber semi-finished product with resin
bringing the fiber semi-finished product into contact with the metallic basic element, wherein the fiber semi-finished product which is saturated with resin is cured by subjection to pressure and heat and thus the at least one reinforcing element is produced and is connected nonreleasably to the basic element.

The object is furthermore achieved by a method for producing a motor vehicle component having a metallic basic element and at least one reinforcing element made of a fiber composite material, comprising the following steps:
depositing an endless fiber strand of fibers impregnated with resin on a former, wherein the former has extensions, the arrangement of which on the former substantially corresponds to the final contour of a fiber semi-finished product, wherein the endless fiber strand is laid in a meandering manner around the extensions such that the two-dimensional fiber semi-finished product is formed
heating the fiber semi-finished product to a temperature lower than the curing temperature of the resin in order to fix the individual fiber strand sections extending between the extensions in the position thereof with respect to one another
trimming the fiber semi-finished product
bringing the fiber semi-finished product into contact with the metallic basic element, wherein the fiber semi-finished product which is saturated with resin is cured by subjection to pressure and heat and thus the at least one reinforcing element is produced and is connected nonreleasably to the basic element.

The two methods illustrated here substantially differ in the type of the fiber materials used.

In the one case, dry fibers are used, and therefore an additional fixing means has to be used in order to fix the individual fiber strand sections in the position thereof with respect to one another.

In the other case, fibers already impregnated with resin are used, and therefore the individual fiber strand sections can already be fixed with respect to one another by the adhesive properties of the resin.

In both cases, the endless fiber strands are deposited on a former. The former has extensions which substantially trace the final contour of a fiber semi-finished product. Within the context of the invention, this should be understood as meaning that the arrangement of the extensions forms an excess size in contrast to the final contour of the fiber semi-finished product.

The final contour of the fiber semi-finished product and the contour formed by the extensions on the former are similar geometrically. This means that angles and distance ratios coincide. The contour on the former is larger here than the final contour of the fiber semi-finished product. The excess size is approximately 1 to 20%, preferably 1 to 10%, of the extent of the final contour of the fiber semi-finished product. This affords the advantage that the ready-deposited fiber semi-finished product can be trimmed very closely to the final contour.

Subsequent deformation of the semi-finished product on or in the metallic basic element is already taken into consideration in the forming of the fiber semi-finished product. The contour of the fiber semi-finished product to a certain extent constitutes a deployed, three-dimensionally configured reinforcing element.

The endless fiber strand can be deposited on the former manually, and a robot configured as desired or other suitable machines can also be used.

The endless fiber strand is guided over the former and guided around one of the extensions. From there, said endless fiber strand is guided to the next provided extension and also laid around the latter. This results in a winding, twisted or coiled pattern of the endless fiber strand, and therefore a two-dimensional fiber semi-finished product is formed. It should be understood in particular under the term “meandering” within the context of the invention. Meandering not only means that individual strand sections of the endless fiber strand are deposited in parallel next to one another on the former, but that the fiber strand sections extending between the extensions are arranged in any position with respect to one another, for example crossing one another or coiling around one another.

The endless fiber strands can also be deposited on the former by a relative movement of the former with respect to the endless fiber strand. This means that the former is moved and/or rotated in space by a suitable mechanism or a robot, wherein the endless fiber strand or the supplying of the endless fiber strand remains substantially fixed in position.

A two-dimensional fiber semi-finished product is produced by the successive winding of the endless fiber strand around the extensions on the former. The surface of the former does not have to be completely covered here with fibers; any desired recesses and holes can also be provided, which is advantageous for the subsequent formation of the reinforcing element since the liquid matrix resin can be brought in a specific manner to certain points of the component by holes, recesses and flow ducts provided intentionally between fiber strand sections.

It can also be provided that holes are produced in the reinforcing element in order, for example, to allow connecting points for further components on the metallic basic element to be free from fibers.

In order to simplify the subsequent transportation and deformation of the fiber semi-finished product after trimming, the individual fiber strand sections which extend between the extensions of the former are fixed in the position thereof with respect to one another.

In the case of fibers which are already preimpregnated, this is possible in a simple manner by the matrix resin being heated to a temperature which is lower than the curing temperature of the specific resin. The matrix resin is thereby liquefied or softened and the individual fiber strands become slightly sticky and can adhere to one another.

In the case of dry fibers, the positional fixing of the individual fiber strand sections with respect to one another can take place by sewing, seaming, by means of an adhesive, by thermoplastic powders or powders reactive in another manner, by liquid adhesive or else by mechanical clamping.

These fixing possibilities can also be provided for the preimpregnated endless fiber strands.

After the fiber strand sections are fixed with respect to one another, the fiber semi-finished product is trimmed. The fibers are severed in the direct vicinity of the extensions within the contour of the extensions on the former. This can be brought about, for example, by a robot-guided knife, manually or by a cutting tool or punching tool.

The trimming resulting here can be configured to be extremely slight by the excess size of the contour of the extensions being configured to be as small as possible in relation to the final contour of the fiber semi-finished product.

In particular, it is also possible for the fiber strands to be severed at the loops which are placed around the extensions. This is preferably implemented on that side of the extensions which faces away from the two-dimensional fiber semi-finished product, and therefore all of the fiber material becomes part of the fiber semi-finished product and hence no waste material remains at all.

This can be provided, for example, whenever a reinforcing element is intended to be formed three-dimensionally with high degrees of deformation and a greater reserve of material is necessary during the deformation.

It is optionally possible for an optionally also additional final trimming to take place after the deformation of the fiber semi-finished product or after the latter has been brought into contact with the metallic basic element.

The use of material can be significantly reduced by minimizing the trimming. As before, fiber materials, such as glass fibers, carbon fibers, aramid fibers or the like, constitute an extremely expensive material, and therefore a significant reduction in costs occurs by minimizing the trimming and therefore minimizing the fiber waste.

The winding depositing of the fiber material on a former provides a more diverse freedom of design in comparison to conventional textile semi-finished products. The customarily used web product in the form of woven or laid fiber fabrics always has a preferred direction caused by the fiber structure. By means of the load-optimized depositing of the endless fiber strands and the use of flexible combinations of material, the properties of the individual materials can be optimally used and, in addition, the weight of the reinforcing elements according to the invention and therefore of the motor vehicle components are optimized.

Furthermore, by means of an optimized configuration of the fiber semi-finished products in respect of the profiles of the endless fiber strands, subsequent processing steps can be influenced to a high extent.

For example, it is possible by the provision of fiber channels in the fiber semi-finished product to provide flow ducts for the matrix resin, which, in particular in the case of fibers which are originally dry, leads to improved impregnatability upon introduction of the matrix resin.

The draping and sliding behavior can be optimized in a subsequent deformation step by skilled fixing of the fiber sections with respect to one another by sewing technology.

It is even possible to optimize the weight per unit area of the fiber semi-finished product by the fiber strand not only being simply deposited but also being expanded over the length thereof. A fiber strand is basically of substantially circular cross section. If the individual fibers of the strand are expanded, it is understood by this that a wider fiber band is formed from the circular fiber strand. In order to cover a certain area with fibers, when a fiber band is used, fewer fiber strand sections are necessary than when the original fiber strands are used. The weight per unit area is therefore reduced.

Furthermore, it is possible to configure the edge regions of the reinforcing elements by tapering-off edge geometries and gentle transitions in such a manner that stress peaks in the edge regions are reduced and therefore to eliminate a source for cracks and fractures under continuous loading.

As a final step during the production of the motor vehicle component according to the invention, the fiber semi-finished product is brought into contact with the metallic basic element. The fiber semi-finished product which is saturated with resin is cured by subjection to pressure and heat and a reinforcing element made of a fiber composite material is produced. At the same time, this reinforcing element is connected nonreleasably to the basic element.

In the case of preimpregnated fibers, the matrix resin is already contained in the fiber semi-finished product.

In the case of dry fibers, the matrix resin has to be introduced into the fiber semi-finished product only retrospectively. For example, the resin is applied to the fiber semi-finished product and is incorporated into the fiber semi-finished product with the aid of a doctor. A further possibility consists in spreading the matrix resin onto the fiber semi-finished product and allowing said matrix resin to penetrate the semi-finished product under the influence of gravity and/or capillary forces. Similarly, the matrix resin can be spread on and can penetrate the fiber semi-finished product when the fiber semi-finished product is pressed onto the metallic basic element.

For bringing into contact, it can simply be the case that the fiber semi-finished product is pressed against the metallic basic element without further deformation.

This is generally the case when the metallic basic element is a simple plate and does not have a three-dimensional design. Similarly, it is possible, when the two parts of the motor vehicle component are brought into contact, to deform the fiber semi-finished product and at the same time to match the latter to the geometry of the metallic basic element or to mold same into the metallic basic element.

Depending on the designated intended use of the motor vehicle component, just one reinforcing element can be attached to the metallic basic element, or a plurality of reinforcing elements are attached. The latter can then be attached simultaneously or successively, at a distance from one another, in an abutting relationship or overlapping. It is also possible to use a plurality of reinforcing elements made of different materials in order optimally to use the material properties.

The method is preferably extended to the fact that load paths initially occurring during loading of the motor vehicle component according to the invention are determined in the reinforcing element and the fiber strand sections are deposited on the former in a manner matched to the load path. This means that, in the event of an accident or in the case of an undesirable deformation of the motor vehicle component, the reinforcing element can optimally absorb the forces occurring. It is also possible here to combine individual fiber materials, such as, for example, aramid, gas, carbon and further customary materials, in such a manner that the reinforcing element can be configured in a manner optimized in terms of the loading.

When the fiber strand sections are deposited on a former, care should be taken to ensure that the individual fiber strand sections change the position thereof and are displaced or slip subsequently during the bringing of the fiber semi-finished product into contact with the metallic basic element and the associated deformation. The draping of the fiber semi-finished product therefore already has to be taken into consideration in the conception of the fiber semi-finished product such that the individual fiber strands are present in the finished reinforcing element in a manner optimized to the load path.

These deformation operations can be considered in simulations. The starting point can therefore be the finished reinforcing element and the load paths can be depicted by corresponding use of material. The shape of the reinforcing element is then calculated back to the two-dimensional fiber semi-finished product and, based on this development, the appropriate material and the corresponding fiber profile are selected for the production of the fiber semi-finished product.

In a further particular embodiment of the invention, it is provided that the fiber semi-finished product is preformed prior to contact with the basic element. This signifies an additional deformation step which, however, may be of advantage in the case of larger reinforcing elements. For example, a corresponding preforming is also conceivable within the context of an RTM process, as a result of which the fiber semi-finished product is impregnated with a matrix resin and is optionally already partially cured.

Further processing steps can be wet pressing processes, hot pressing processes or thermoforming, which can all be associated with preforming the fiber semi-finished product. The basic element is particularly preferably connected to the reinforcing element by an adhesive agent. An adhesive agent here can be, for example, an adhesive which forms an integrally bonded connection between the two elements. However, the adhesive agent can also be the matrix resin itself, by means of which the reinforcing element is connected adhesively to the basic element.

Particularly whenever a preformed fiber semi-finished product is already present, the matrix resin of which is already partially cured, the connection between the reinforcing element and the basic element can be improved by an adhesive agent.

Furthermore, the invention relates to a motor vehicle component having a metallic basic element and at least one reinforcing element made of a fiber composite material, which is preferably produced according to a method as presented above.

A motor vehicle component according to the invention can be, for example, an A pillar or a B pillar or a bumper or a side impact member of a motor vehicle. These are provided with reinforcing elements made of fiber composite material in order to improve the crash properties of the vehicle components.

It is possible here not only to provide the metallic basic element with one reinforcing element but also to introduce a plurality of reinforcing elements, depending on requirements and designated intended purpose of the component.

In particular, the orientation of the individual fiber strands in the reinforcing element is matched to the load paths occurring during loading of the motor vehicle component. This signifies an optimization of reinforcing elements according to the invention since an optimized absorption of energy is brought about, for example, in the event of a crash, by matching the fiber profiles in the reinforcing element to the load paths. As a result, the entire component is deformed to a less severe extent and the safety of the vehicle occupants is greatly increased.

The entire structure of the weight of the reinforcing element is optimized by the optimum use of material by depositing the fiber strands in a manner suitable for the load paths and the targeted use of suitable materials.

In contrast to conventional fiber products in the form of woven or laid fiber fabrics, the material is arranged in the reinforcing element in a specific manner. In the case of conventional fiber products, there is inevitably a preferred direction, and therefore matching to the load paths is possible only within narrow limits.

In the figures below, possibilities of using the present invention are explained by way of example.

All of the described or graphically illustrated features by themselves or in any meaningful combination form the subject matter of the present invention, also irrespective of the summary thereof in the claims or the dependency reference of the latter.

### BRIEF DESCRIPTION OF THE DRAWINGS

FIG. 1 shows an exemplary configuration of a motor vehicle component according to the invention.

FIG. 2 shows a former according to the invention.

### DETAILED DESCRIPTION

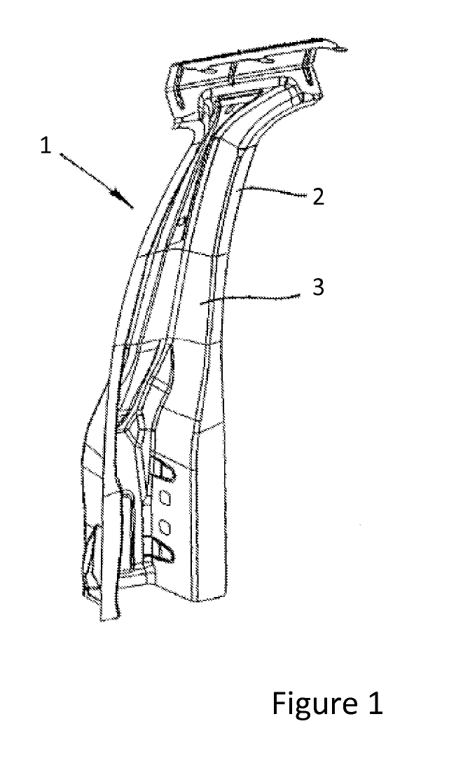

A motor vehicle component 1 consists of a metallic basic element 2 and a reinforcing element 3. FIG. 1 illustrates by way of example using a B pillar how a motor vehicle component 1 according to the invention could look. The metallic basic element 2 is a customarily formed motor vehicle B pillar which is provided with a reinforcing element 3 made of a fiber composite material. The reinforcing element 3 has a fiber profile which is matched to the load paths, and therefore, in the event of an accident, during deformation of the B pillar or during loading of the B pillar, the energy introduced into the motor vehicle component 1 can be optimally absorbed by the reinforcing element 3.

It is thereby avoided that the motor vehicle component 1 is deformed to too great an extent and penetrates the vehicle interior and therefore that vehicle occupants are injured.

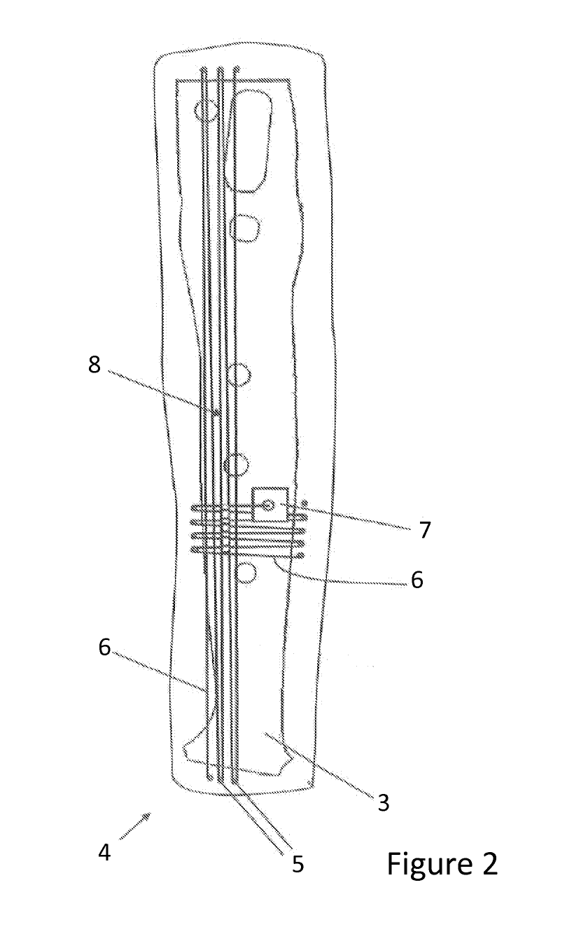

A reinforcing element 3 can be produced with a aid of a former 4, as illustrated in FIG. 2. The former 4 has extensions 5 which are arranged on the former 4 in such a manner that they trace the contour of a two-dimensional fiber semi-finished product 8. Not all of the extensions 5 are illustrated in FIG. 2 so as to keep FIG. 2 somewhat clearer. A reinforcing element 3 is shown once again here in order to illustrate how the extensions 5 trace the outer contour of the reinforcing element 3. A laying head 7 which is attached, for example, to a robot guides a fiber strand 6 in a meandering manner from one extension 5 to the next. In the present case, the fiber strands 6 are deposited in a zigzag pattern. The laying head 7 guides the fiber strand 6 from one extension 5 to a further extension 5 which is arranged on the opposite side of the former.

The fiber strand 6 is laid around the extension 5 and is then drawn to the next extension 5 provided. A two-dimensional fiber semi-finished product 8 is thereby successively constructed. In this example, the individual fiber strands 6 have a preferred direction longitudinally and transversely with respect to the extent of the fiber semi-finished product 8. However, it is possible, within the context of the invention, to draw the fiber strands 6 from one extension 5 to a further extension 5 as desired and thus to realize any desired profiles of the fiber strands 6.

As soon as the laying of the fiber strand 6 is finished, the individual fiber strands 6 are fixed in the position thereof with respect to one another. The fixing can take place, for example, by sewing or seaming. A powder binder can be dusted on and is then heated and adhesively bonds the fiber strands 6 to one another. However, it can also be provided that the fiber strands 6 themselves are already impregnated with matrix resin and the matrix resin itself is brought into a sticky state, for example by heating, and the fiber strands 6 then stick on one another.

After the fiber strands 6 are fixed in position with respect to one another, the two-dimensional fiber semi-finished product 8 is trimmed. The trimming is undertaken along the contour of the reinforcing element 3 as close as possible to the extensions 5 in order to keep the trimming of the fibers, and therefore the amount of fiber waste, as small as possible.

The two-dimensional fiber semi-finished product 8 is then removed from the former 4 and brought into contact with a metallic basic element 2 and connected to the latter by subjection to pressure and heat.

The result is a motor vehicle component 1 with an optimized fiber orientation making it possible ideally to dissipate loadings which occur.

When the fiber strands 6 are laid with the aid of the laying head 7, any desired fiber materials can be used.

The fiber materials can also be changed in a suitable manner during the laying of the fiber strands 6.

It is possible according to the invention to provide fibers of different materials, for example a mixture of glass and carbon fibers, within a fiber strand 6.

It is possible, within the context of the invention, also for fibers made of thermoplastic or thermosetting material to also be incorporated into the fiber strand, and therefore the matrix material is thereby already present in the two-dimensional fiber semi-finished product 8.

The completion of the reinforcing element 3 made from the two-dimensional fiber semi-finished product 8 is possible by a multiplicity of processes. These include, for example, RTM methods or wet pressing methods or thermopressing methods and the like, which are all known to the professional world.

It is likewise possible to produce the reinforcing element 3 by laminating individual fiber strands successively to form a reinforcing element 3. This means adding each individual fiber strand 6 to the reinforcing element 3 under temperature and pressure and at least partially curing same. In this case, the two-dimensional fiber semi-finished product 8 would be a semi-finished product which is close to the final contour and, at the end of the production thereof, merely still has to be connected to the metallic basic element 2 in an integrally bonded manner.

In this case, use is preferably made of preimpregnated fiber strands 6 since the matrix resin is already integrated there in an advantageous manner in the fiber strand 6 and does not have to be added in an additional working step.

### LIST OF REFERENCE NUMBERS

1. Motor vehicle component
2. Basic element
3. Reinforcing element
4. Former
5. Extensions
6. Fiber strand
7. Laying head
8. Fiber semi-finished product

What is claimed is:

1. A method for producing a motor vehicle component having a metallic basic element and at least one reinforcing element made of a fiber composite material, comprising:
depositing an endless fiber strand of dry fibers on a former, wherein the former has extensions, the arrangement of which on the former substantially corresponds to the final contour of a fiber semi-finished product, wherein the endless fiber strand is laid in a meandering manner around the extensions such that the two-dimensional fiber semi-finished product is formed
fixing the individual fiber strand sections extending between the extensions in the position thereof with respect to one another trimming the fiber semi-finished product providing the fiber semi-finished product with matrix resin
bringing the fiber semi-finished product into contact with the metallic basic element, wherein the fiber semi-finished product which is saturated with matrix resin is cured by subjection to pressure and heat and thus the at least one reinforcing element is produced and is connected nonreleasably to the basic element.

2. A method for producing a motor vehicle component having a metallic basic element and at least one reinforcing element made of a fiber composite material, comprising the following steps:
depositing an endless fiber strand of fibers impregnated with matrix resin on a former, wherein the former has extensions, the arrangement of which on the former substantially corresponds to the final contour of a fiber semi-finished product, wherein the endless fiber strand is laid in a meandering manner around the extensions such that the two-dimensional fiber semi-finished product is formed
heating the fiber semi-finished product to a temperature lower than the curing temperature of the matrix resin in order to fix the individual fiber strand sections extending between the extensions in the position thereof with respect to one another
trimming the fiber semi-finished product
bringing the fiber semi-finished product into contact with the metallic basic element, wherein the fiber semi-finished product which is saturated with matrix resin is cured by subjection to pressure and heat and thus the at least one reinforcing element is produced and is connected nonreleasably to the basic element.

3. The method as claimed in claim 1, wherein load paths initially occurring during loading of the motor vehicle component are determined in the reinforcing element and fiber strand sections are deposited on the former in a manner matched to the load path.

4. The method as claimed in claim 1, wherein the fiber semi-finished product is preformed prior to contact with the basic element.

5. The method as claimed in claim 1, wherein the basic element and the reinforcing element are connected to each other by an adhesive agent.

6. A motor vehicle component having a metallic basic element and at least one reinforcing element made of a fiber composite material which is produced in particular according to a method as claimed in claim 1, wherein the orientation of the individual fiber strands in the reinforcing element is matched to the load paths occurring during loading of the motor vehicle component.
